(19) United States
(12) Patent Application Publication
(10) Pub. No.: US 2021/0354640 A1
(43) Pub. Date: Nov. 18, 2021

(54) RETRACTABLE BATHROOM DEVICE

(71) Applicant: John DiGiorgio, Mobile, AL (US)

(72) Inventor: John DiGiorgio, Mobile, AL (US)

(21) Appl. No.: 17/323,985

(22) Filed: May 18, 2021

Related U.S. Application Data
(60) Provisional application No. 63/026,456, filed on May 18, 2020.

(51) Int. Cl. B60R 15/02; B60R 15/04; E03D 7/00; E04B 1/343

(52) U.S. Cl. CPC B60R 15/02; E04B 1/34357; E03D 7/00; B60R 15/04

(57) ABSTRACT

A retractable bathroom device that unfolds to provide bathroom facilities to a user is provided. The system generally comprises a deployment device and a folding frame having a shower incorporated therein. Other preferred embodiments of a retractable bathroom may further comprise a sink and/or a toilet. A user may unfold the retractable bathroom device using the deployment device and then use the facilities. Once finished, the user may fold the retractable bathroom device for storage using the deployment device. A water pump may transfer water from a water tank operably connected to the system, and drains of the system may return grey/black water thereto. Heating elements of the water tank may prevent water within from freezing.

### CROSS REFERENCES

This application claims the benefit of U.S. Provisional Application No. 63/026,456, filed on May 18, 2020, which application is incorporated herein by reference.

### FIELD OF THE DISCLOSURE

The subject matter of the present disclosure refers generally to a retractable bathroom that may be folded in order to reduce its profile when not in use.

### BACKGROUND

Truck fleets often have very high driver turnover largely due to job dissatisfaction. Truck drivers spend the vast majority of their time at work inside the cab of the truck they are driving, so one-way fleet managers can increase the job satisfaction of their drivers and decrease driver turnover is by adding amenities to the trucks, wherein said amenities make the drivers' lives more comfortable. One such addition is to add a bathroom to the truck, which may include a toilet and/or a shower. However, custom trucks with sleepers having showers can cost as much or more than $300,000, which is a price many fleets cannot afford. Further, the addition of a toilet inside the cab can result in bad odors that can actually decrease the driver's quality of life. Additionally, the larger size of many sleeper cabs that include a shower and/or toilet necessitate a larger turn radius, making it more difficult to maneuver the truck. The additional length of the cab can also reduce carrying capacity due to some state laws limiting the overall length of loaded semis.

The benefits of adding showers to semi-trucks can be seen for emergencies, such as the COVID-19 pandemic, as well. Granting truck drivers the ability to limit exposure to viruses during pandemics could not only increase the quality of life by decreasing driver stress, but it could also increase the ability of fleets to transport goods in shorter periods of time since drivers could take more direct routes to their destination without the need to factor in shower/bathroom facilities along their routes. More direct routes could also decrease shipping costs since it could decrease maintenance and gas costs for drivers and fleets, which could be reflected in retail prices at stores to consumers.

Accordingly, there is a need in the art for a foldable bathroom that may be attached to a semi-truck so that truck drivers may take showers on the go without greatly increasing cab length or decreasing carrying load.

### SUMMARY

A system may be attached to transport vehicles in a way that allows users to move the retractable bathroom from a storage area located on the storage vehicle to a deployment area to the side of the transport vehicle where the retractable bathroom may be unfolded by the user and subsequently used is provided. In one aspect, the system is a foldable bathroom that may be attached to the back of semi-trucks after folding to reduce its profile. In another aspect, the system is a portable bathroom that may be attached as addons to various buildings or used at large events where infrastructure is limited. The system generally comprises a deployment device, folding frame, shower, water tank, water supply lines, and water pump. In addition to or in lieu of the shower, some embodiments of a retractable bathroom may comprise a folding sink, toilet, shelf, mirror, shower tray, towel holder, airbag/shock access panels. In another embodiment, a user control of the deployment device may cause the deployment device to manipulate the foldable frame for the user, obviating the necessity of the user to place the retractable bathroom in a useable position manually.

The folding frame generally comprises a cab panel, top panel, top folding panel, floor panel, folding floor panel, back panel, first side panel, second side panel, access panel, and folding wall. The floor panel, first side panel, and second side panel are fused to the cab/top side panel in a way such that the folding floor panel attached to the floor panel, access panel attached the first side panel, and folding wall attached to the second side panel open away from the cab/top side panel. The folding floor panel is preferably generally parallel with the top folding panel when fully extended, and the access panel and folding wall generally form a 90-degree angle with the top folding panel when extended. The back panel is configured to slide in a way such that it generally remains parallel with the cab panel and may operably connect to the top folding panel, folding floor panel, access panel, and folding wall in a way such that the folding frame may be secured in an open position. In one preferred embodiment, rails of the cab/top panel may allow the back panel to slide into an opened and folded position. These rails may also provide an additional framework for the various folding pieces of the folding frame to be attached. A frame of the access panel is rotatable attached to the first side panel and is configured to secure to said top folding panel and said back panel when in an open position. A user may access the interior of the retractable bathroom device via a door of the access panel.

The deployment device helps move the folding frame from a first position to a second position, wherein the first position has space that requires the folding frame to be in a folded position and the second position has space that allows the folding frame to be in an open position. The deployment device may also be used to manipulate the folding frame in a way such that it place said folding frame in a folded position and open position. The deployment device preferably comprises a pneumatic device and/or hydraulic device that can be used to move the retractable bathroom form the first position to the second position and/or manipulate the folding frame. A user control may be used by the user to cause the deployment device to manipulate the retractable bathroom. The user control is preferably a computing device that is operably connected to the deployment device in a way such that allows the user to manipulate retractable bathroom. The computing device may be located in the cab of the transport vehicle so that the user may manipulate the retractable bathroom without having to leave the transport vehicle.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a diagram illustrating a system embodying features consistent with the principles of the present disclosure.

FIG. 2 is a diagram illustrating a system embodying features consistent with the principles of the present disclosure.

FIG. 3 is a diagram illustrating a system embodying features consistent with the principles of the present disclosure.

FIG. 4 is a diagram illustrating a system embodying features consistent with the principles of the present disclosure.

FIG. 5 is a diagram illustrating a system embodying features consistent with the principles of the present disclosure.

FIG. 6 is a diagram illustrating a system embodying features consistent with the principles of the present disclosure.

FIG. 7 is a diagram illustrating a system embodying features consistent with the principles of the present disclosure.

FIG. 8 is an environmental view of a system embodying features consistent with the principles of the present disclosure.

FIG. 9 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Although the description generally refers to protecting individuals within rear seating areas of a vehicle, one with skill in the art will understand that the system may be used to protect individuals within other areas of a vehicle without departing from the inventive subject matter described herein.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. The term “computing device” and grammatical equivalents thereof are used herein to mean clients that a user may use to manipulate the system or that may manipulate the outside the user's control. For instance, a client may include a personal computer, a wireless telephone, a touch screen control panel, a personal digital assistant (PDA), a laptop, a smart phone, a tablet computer, or another type of computation or communication interface. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

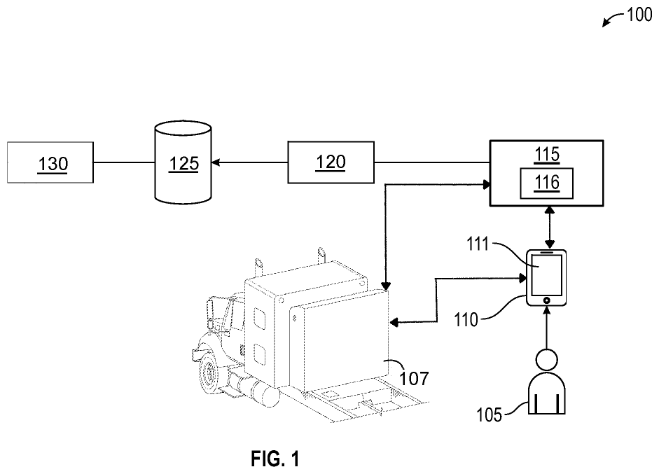

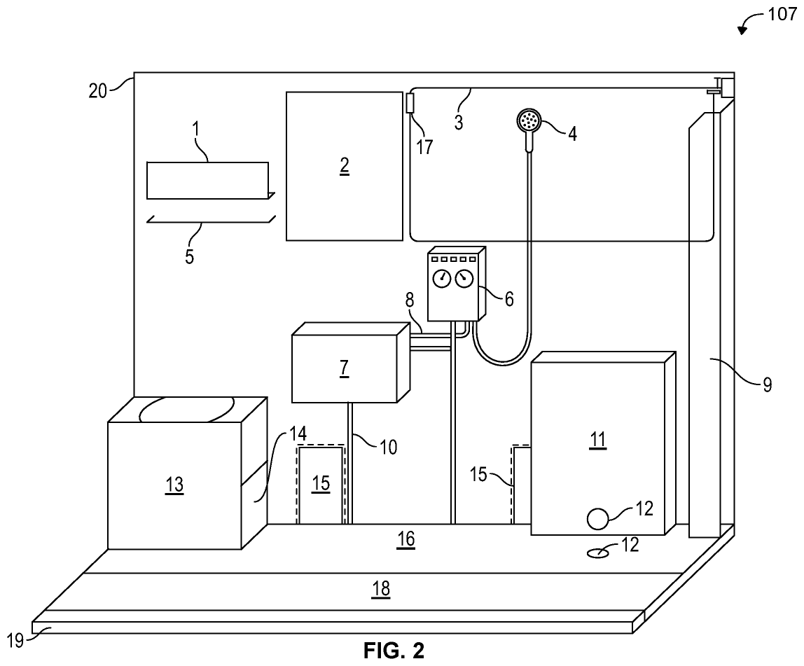

FIGS. 1-9 illustrate embodiments of a system 100 and method 900 for a retractable bathroom 107. As illustrated in FIGS. 1-8, the system 107 generally comprises a deployment device and a folding frame having a shower incorporated therein. Other preferred embodiments of a retractable bathroom 107 may further include, but are not limited to, a user control 110, at least one sensor 108, processor 115, non-transitory computer-readable medium 116, server 120, database 125, shelf 1, mirror 2, towel holder 5, sink 7, shower tray 11, toilet 13, airbag/shock access panels, or any combination thereof. In a preferred embodiment, as illustrated in FIG. 2, the shower, sink 7, and toilet 13 of the retractable bathroom 107 are foldable and/or rotatable within the folding frame such that the profile of the retractable bathroom 107 may be reduced when not in use. The retractable bathroom 107 may be constructed in a way such that the folding frame, shower, sink 7, and toilet 13 are one unit. For instance, the toilet 13 may be fused to an interior wall of the folding frame in a way such that the toilet 13 and folding frame are a single unit. Alternatively, the folding frame, shower, sink 7, and toilet 13 may be constructed separately and combined at a later time. For instance, the folding frame, sink 7, and toilet 13 may be constructed in a way such that one may purchase the retractable bathroom 107 with only a shower with the ability to add the sink 7 and toilet 13 to the retractable bathroom 107 at a later time.

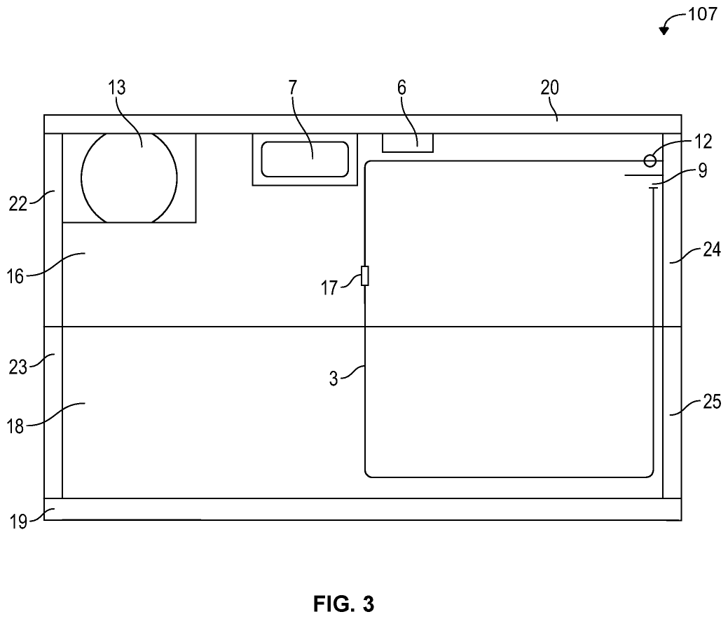

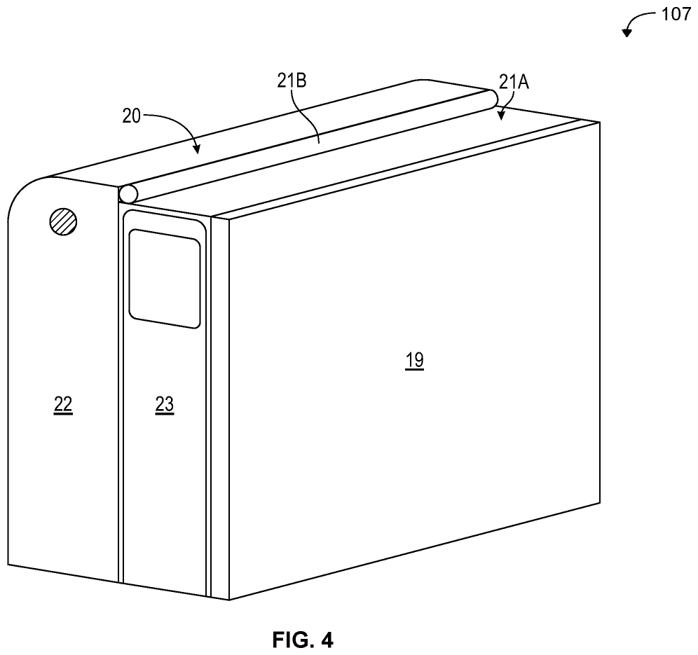

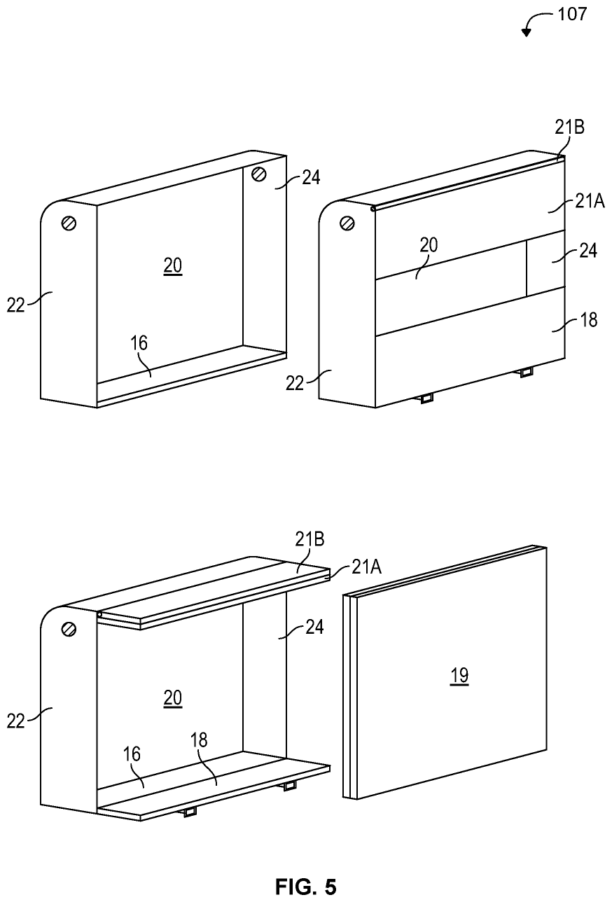

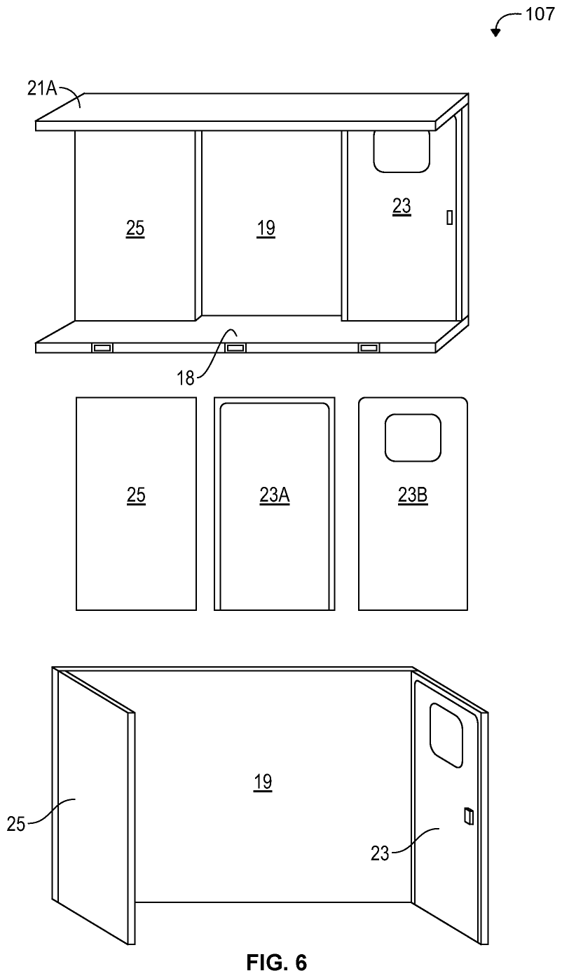

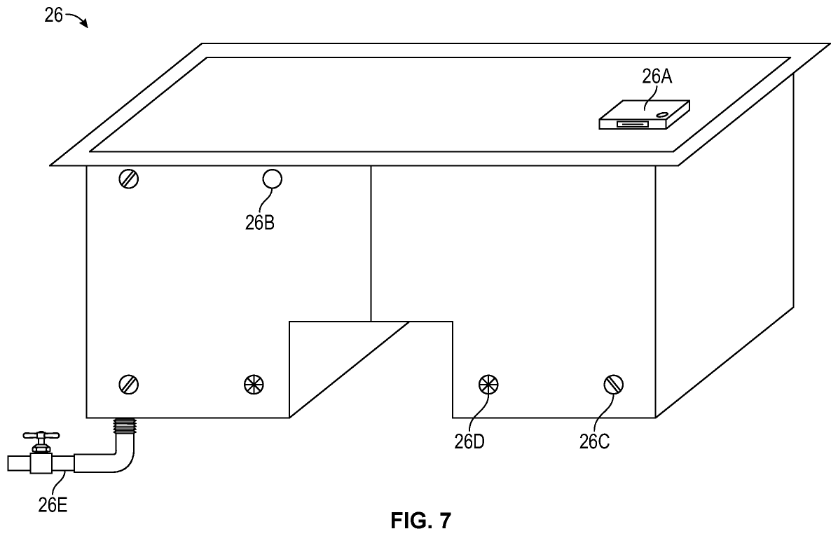

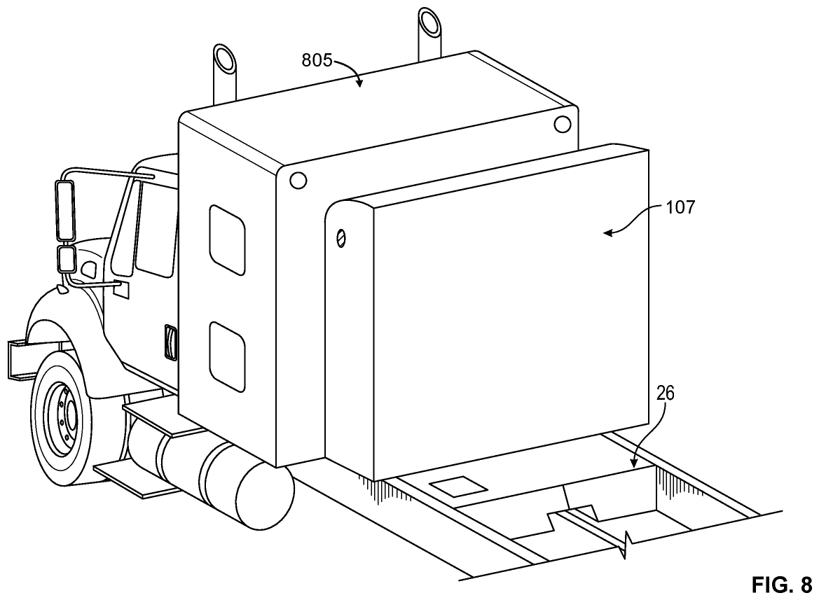

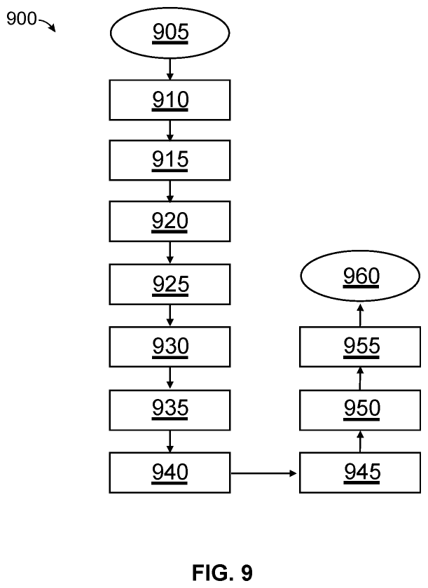

Although the retractable bathroom 107 and method of the present disclosure have been discussed for use within the semi-truck transportation field, one of skill in the art will appreciate that the inventive subject matter disclosed herein may be utilized in other fields or for other applications in which a retractable bathroom 107 may be needed. For instance, the retractable bathroom 107 could be attached to barracks of military bases as a way to provide showers to those in the field while reducing the amount of space required. It is understood that the various method steps associated with the methods of the present disclosure may be carried out by a user 105 using the retractable bathroom 107 shown in FIGS. 1-8. FIG. 2 illustrates the various components of a retractable bathroom 107 that may be used to take a shower. FIG. 3 illustrates a bird's eye view of the various components of a retractable bathroom 107. FIG. 4 illustrates a perspective view of a retractable bathroom 107 in an open position. FIGS. 5 and 6 illustrate views of the retractable bathroom 107 and how the various panels of the frame may fit together. FIG. 7 illustrates the water tank 26 of the retractable bathroom 107. FIG. 8 illustrates how a retractable bathroom 107 in a closed position may be attached to a semi-truck 805. FIG. 9 illustrates a method 900 a user 105 may use to deploy the retractable bathroom 107 so that they may take a shower.

The deployment device assists a user 105 when placing the retractable bathroom 107 in an open or closed position. In one preferred embodiment, a retractable bathroom 107 in a closed position may be extended from one location, where there is only enough room for to store said retractable bathroom 107 if it is in said closed position, to another location, in which there is enough room to be placed in an open position, or vice versa. For instance, a retractable bathroom 107 may be stored between a cab of a semi-truck 805 and a trailer when not in use, but may be placed to the side of the cab of the semi-truck 805 and trailer by the deployment device when a user 105 desires to use the shower, sink 7, and/or toilet 13. In a preferred embodiment, the deployment device comprises a pneumatic device or hydraulic device. The pneumatic/hydraulic device may comprise a pump, fluid, reservoir, control valves, a user control 110, an actuator connected to the pump via a plurality of tubes, and a plurality of seals. The pump supplies the fluid to the various components of the hydraulic/pneumatic device. The control valves direct the fluid to various locations of the hydraulic/pneumatic device via the plurality of tubes. In a preferred embodiment, the user control 110 is a computing device that is operably connected to the control valves in a way such that a user 105 may operate the computing device in a way that instructs the control valve which route through the plurality of tubes the fluid may take to the actuator. The actuator is responsible for moving objects using the work force generated by the pressure changes caused by the fluid. The reservoir holds fluid, which may be a liquid or gas, not currently being used to operate the hydraulic/pneumatic device. The plurality of seals prevents the escape of fluid from the hydraulic/pneumatic device.

In a preferred embodiment, the actuator further comprises a hydraulic/pneumatic cylinder defined by an internal cavity, a slidably moveable piston disposed within the internal cavity, and a strut operably connected to the slidably moveable piston. The slidably moveable piston may be shaped in a way such that it creates two chambers within the cavity. In a preferred embodiment, the hydraulic/pneumatic cylinder may be operably connected to the actuator in a way such that a computing device manipulates the control valve so that it directs fluid pumped by the pump into one of a first chamber or a second chamber of the hydraulic/pneumatic cylinder. Pressure change resulting from fluid being injected into the first chamber or second chamber acts on the slidably moveable piston, causing the slidably moveable piston to move in a direction from higher pressure to lower pressure. The strut is projected out the strut end of the hydraulic/pneumatic device and is coupled to the folding frame of the retractable bathroom 107. Operating the hydraulic/pneumatic device to cause the slidably moveable piston to move in a direction from higher pressure to lower pressure causes the strut to move in a linear direction, which in turn causes the retractable bathroom 107 to change locations and/or positions. For instance, a plurality of hydraulic/pneumatic devices may be attached to the retractable bathroom 107 in a way such that a user 105 may move the retractable bathroom 107 to a new location along the X, Y, and Z planes as well as change the position of the retractable bathroom 107 from a closed position to an open position or vice versa.

The folding frame, as illustrated in FIGS. 2-6, generally comprises a cab panel 20, top panel, top folding panel 21A, 21B, floor panel 16, folding floor panel 18, back panel 19, first side panel 22, second side panel 24, access panel 23, and folding wall 25. Materials that may be used to construct the folding frame include, but are not limited to, plastic, aluminum, fiberglass, steel, or any combination thereof. In a preferred embodiment, the cab panel and top folding panel 21A, 21B are fused to create a cab/top panel having a top folding panel 21A, 21B that generally creates a 180-degree angle with the cab/top panel 20 when in an open position, as illustrated in FIGS. 3 and 4. Access panels 15 may be incorporated into the cab panel to allow a user 105 to access airbags and/or shocks. In one preferred embodiment, a shower tray 11 may be incorporated into the cab panel as well; however, the shower tray 11 may also be configured to attach to the cab panel, allowing a user 105 to remove it entirely or replace it with a different shower tray 11 if desired. The floor panel 16, first side panel 22, and second side panel 24 are fused to the cab/top side panel in a way such that the folding floor panel 18 attached to the floor panel 16, access panel 23 attached the first side panel 22, and folding wall 25 25 attached to the second side panel 24 open away from the cab/top side panel 20.

The folding floor panel 18 is preferably generally parallel with the top folding panel 21A, 21B when fully extended, and the access panel 23 and folding wall 25 generally form a 90-degree angle with the top folding panel 21A, 21B when in an open position. The back panel 19 may slide in a way such that it remains generally parallel with the cab/top panel 20 and may operably connect to the top folding panel 21A, 21B, folding floor panel 18, access panel 23, and folding wall 25 in a way such that the retractable bathroom 107 may be securely fastened in an open position. In one preferred embodiment, the back panel 19 may slide along rails attached to the cab/top panel 20, which may provide an additional framework that the various folding pieces may be secured to. The access panel 23 preferably comprises a frame 23A and door 23B, wherein the frame 23A attaches to the first side panel 22 and back panel 19 and the door 23B fits inside said frame 23B. A user 105 may access the interior of the retractable bathroom device 107 via the door 23B.

The shower of the retractable bathroom 107 may comprise a water tank 26, water pump, water supply lines 8, water heater 6, shower head 4, shower curtain rod 3, and a shower curtain 9. Other preferred embodiments of a shower may include a folding shower tray 11. A plurality of drain holes 12 located in the cab panel, floor panel 16, first side panel 22, and second side panel 24 may allow water to drain from the retractable bathroom 107. In one preferred embodiment, drain pipes 10 may extend from the drains of the retractable bathroom 107 to a water tank, as illustrated in FIGS. 2 and 7. In a preferred embodiment, the water heater 6 is a tankless hot water heater 6. The water heater 6 is designed to heat water pumped from the water pump and subsequently supply said water to the user 105 via the shower head 4 by way of the water supply lines 8. In other preferred embodiments, the water heater 6 may be operably connected to the sink 7 in a way such that it may provide hot water thereto. Cold water may be pumped by the water pump to the shower and/or sink 7 directly from the water tank 26 by way of the water supply lines 8, which may allow a user 105 to adjust the temperature of the water as desired.

In a preferred embodiment, a first end and second end of the shower curtain rod 3 is connected to the second side panel 24. The shower curtain rod 3 is preferably shaped in a way such that an attached shower curtain 9 may form a compartment when extended from said first end to said second end of said shower curtain rod 3, as illustrated in FIG. 3. The rod preferably comprises at least two joints so that the shower curtain rod 3 may be placed in a folded position when the retractable bathroom 107 is in a closed position (illustrated in FIG. 8) or an extended position (illustrated in FIG. 4) when the retractable bathroom 107 is placed in an open position. In one preferred embodiment, a locking element 17 and at least one aperture of the shower curtain rod 3 may be used to hold the shower curtain rod 3 in an extended position. Apparatuses that may act as the locking element 17 include, but are not limited to, push-pull pins, clamps, set knobs, snap locks, spring buttons, and clutch locks, or any combination thereof. In another preferred embodiment, the shower curtain rod 3 may be operably connected to the top folding panel 21A, 21B in a way such that when the top folding panel 21A, 21B is folded into a closed position or open position, the shower curtain rod 3 is placed into a folded position or extended position, respectively.

In one preferred embodiment, the retractable bathroom 107 may further comprise a sink 7, as illustrated in FIGS. 2 and 3, which is preferably foldable. The folding sink 7 comprises a water basin, faucet, and water supply lines 8. The water basin is preferably configured in a way such that a user 105 may fold the water basin up and/or down into a folded position when the folding sink 7 is not in use, thus decreasing the profile of the folding sink 7. In one preferred embodiment, a user 105 may fold the sink 7 up and lock it into place using a locking element 17 and aperture, wherein folding the water basin up may cause it to cover a mirror 2 and/or shelf 1 located above the sink 7. In another preferred embodiment, a user 105 may lock the water basin in an unfolded position via said locking element 17 and said aperture. In another preferred embodiment, a pneumatic/hydraulic device may be used to place the folding sink 7 in a folded or unfolded position, depending on the position of the retractable bathroom 107. The water supply lines 8 run to the faucet from the water pump and water heater 6 and may provide cold and hot water, respectively, to a user 105 via the faucet head. A user 105 may control the temperature of the water by controlling valves of the faucet that are responsible for the flow of cold and hot water through the water supply lines 8. Water that enters the water basin is preferably carried to a water tank 26 via the water supply lines 8 that run from the drain hole 12 of the water basin to said water tank 26.

In another preferred embodiment, the retractable bathroom 107 may further comprise a toilet 13, as illustrated in FIGS. 2 and 3, which is preferably rotatable. The toilet 13 comprises a toilet basin, flushing lever, water release valves, water supply lines 8, and a drain pipe 10. Some preferred embodiments may further comprise a toilet entry door 14. The toilet basin is preferably configured to rotate about a central axis in a way such that it is placed in an unrotated position (meaning its longest dimension is generally parallel to the front panel) when the retractable bathroom 107 is in a closed position and is placed in a rotated position (meaning its longest dimension is generally perpendicular to the front panel) when the retractable bathroom 107 is placed in an open position. In one preferred embodiment, a pneumatic/hydraulic device may be used to place the toilet 13 in a unrotated position or rotated position, depending on the position of the retractable bathroom 107. The water supply lines 8 run to the water release valves of the toilet basin from the water pump and may provide water to the toilet 13. A user 105 may release water into the toilet basin by operating the flushing lever, which may cause the water release valves to open, thus releasing the water of the water supply lines 8. Water that enters the toilet basin is preferably carried to a water tank 26, illustrated in FIG. 7, via the drain pipe 10 that runs from the bottom of the toilet basin to said water tank 26. In another preferred embodiment, the toilet 13 may be a composting toilet, which may eliminate the necessity for water supply lines 8 and a drain pipe 10.

The water tank 26 is preferably configured to hold fresh water and grey/black water. A divider within the tank separates the fresh water from the grey/black water. A user 105 may add water to the water tank 26 using an access panel 26A of the water tank 26. The water pump may pull fresh water from the water tank 26 via an output hole 26C and provide it to the various components of the retractable bathroom 107. Grey/black water may then be returned to the water tank 26 through the receiving hole 26B via a drain pipe 10. A user 105 may drain water from the water tank 26 using a water dump hole when necessary. For instance, a user 105 may remove water from the water tank 26 via the water dump hole to prevent water from going stale within the water tank 26 if a semi-truck 805 may go unused for an extended period of time. Heating elements 26D within the water tank 26 may prevent the water from freezing. In a preferred embodiment, the heating elements 26D use resistive heating to heat the water within the water tank 26. A user 105 may remove grey/black water from the system 100 using the purging line 26E, as illustrated in FIG. 7. In some preferred embodiments, the purging line 26E is extendable in a way such that a user 105 may extend the purging line 26E to a dump site in order to dump the grey/black water into the dump site, and then the user 105 may retract the purging line 26E for more confined storage.

As mentioned previously, one embodiment of the system 100 may further comprise a user control 110 in the form of a computing device. A computing device may be implemented in a number of different forms, including, but not limited to, touch screens control panels, multipurpose computers, mobile computers, etc. For instance, a computing device may be implemented in a multipurpose computer that acts as a personal computer for a user 105, such as a laptop computer. For instance, components from a computing device may be combined in a way such that a mobile computing device is created, such as mobile phone. Additionally, a computing device may be made up of a single computer or multiple computers working together over a network. For instance, a computing device may be implemented as a single server 120 or as a group of servers 120 working together over and Local Area Network (LAN), such as a rack server system. Computing devices may communicate via a wired or wireless connection. For instance, wireless communication may occur using a Bluetooth, Wi-Fi, or other such wireless communication device.

A processor 115 of the computing device is configured to perform the operations disclosed herein based on instructions stored within the system 100. The processor 115 may process instructions for execution within computing device, including instructions stored in memory or on a storage device, to display graphical information for a graphical user interface (GUI) on an external input/output device, such as a display. The processor 115 may provide for coordination of the other components of a computing device, such as control of user interfaces 111, applications run by a computing device, and wireless communication by a communication device of the computing device. The processor 115 may be any processor or microprocessor suitable for executing instructions. In some instances, the processor 115 may be a component of a larger computing device. A computing device that may house the processor 115 therein may include, but are not limited to, laptops, desktops, workstations, personal digital assistants, servers 120, databases 125, cellular telephones, tablet computers, or any other similar device. Accordingly, the inventive subject matter disclosed herein, in full or in part, may be implemented or utilized in devices including, but are not limited to, laptops, desktops, workstations, personal digital assistants, servers 120, databases 125, cellular telephones, tablet computers, or any other similar device.

In an embodiment, the programming instructions responsible for the operations carried out by the processor 115 are stored on a non-transitory computer-readable medium 116 (“CRM”), which may be coupled to the computing device. Alternatively, the programming instructions may be stored or included within the processor 115. Examples of non-transitory computer-readable mediums 116 include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions may be stored as modules within the non-transitory computer-readable medium 116.

A user interface 111 may be defined as a space where interactions between a user 105 and the system 100 may take place. In a preferred embodiment, the interactions may take place in a way such that a user 105 may control the operations of the system 100, and more specifically, allow a user 105 to manipulate the retractable bathroom by controlling the deployment device. A user 105 may input instructions to control operations of the system 100 manually using an input device. For instance, a user 105 may choose to change the position of the retractable bathroom by using an input device of the system 100, including, but not limited to, a keyboard, mouse, or touchscreen. A user interface 111 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, or any combination thereof. The system 100 may present data of the user interface to the user via a display operably connected to the processor 115.

A display may be defined as an output device that communicates data that may include, but is not limited to, visual, auditory, cutaneous, kinesthetic, olfactory, and gustatory, or any combination thereof. Information presented via a display may be referred to as a soft copy of the information because the information exists electronically and is presented for a temporary period of time. Information stored on the non-transitory computer-readable medium 116 may be referred to as the hard copy of the information. For instance, a display may present a soft copy of a visual representation of the position of retractable bathroom via a liquid crystal display (LCD), wherein the hard copy of the visual representation of the position of retractable bathroom may be stored on a local hard drive. For instance, a display may present a soft copy of audio information via a speaker, wherein the hard copy of the audio information is stored on a flash drive. For instance, a display may present a soft copy of temperature data 130, wherein the hard copy of the temperature data 130 is stored within the non-transitory computer-readable medium 116. Displays may include, but are not limited to, cathode ray tube monitors, LCD monitors, light emitting diode (LED) monitors, gas plasma monitors, screen readers, speech synthesizers, haptic suits, speakers, and scent generating devices, or any combination thereof, but is not limited to these devices.

In some preferred embodiments, at least one sensor 108 may be secured within the water tank in a way such that it may measure and transmit temperature data 130 to the computing device. The computing device may then use this information to perform the various functions of the system 100. For instance, a computing device connected to the at least one sensor 108 may receive temperature data 130 collected by said at least one sensor 108, process said data, and allow power to be transferred from the power supply the heating coils to prevent water in the water tank from freezing. The retractable bathroom may comprise other types of sensors that the system 100 may use as well. Types of sensors that may be used as an at least one sensor 108 include, but are not limited to, a thermometer, hygrometer, gas detector, microphone, vibration sensor, ultrasonic sensor, infrared sensor, microwave sensor, photoelectric sensor, time-of-flight sensor, accelerometer, gyroscope, or any combination thereof.

The power supply supplies power to the deployment device, water pump, heating elements 26D, and lights of the retractable bathroom 107. In another preferred embodiment, the power supply may provide power to an electric tankless hot water heater 6 of the retractable bathroom 107. The power supply may be any source of power that provides the retractable bathroom 107 with electricity. In one preferred embodiment, the retractable bathroom 107 may comprise of multiple power supplies that may provide power in different circumstances. For instance, the retractable bathroom 107 may be connected to the auxiliary power unit alternator of the semi-truck 805, which may provide power to the retractable bathroom 107 so long as the engine is idle. However, the retractable bathroom 107 may also be connected to a backup battery so that it may receive power even when the engine of a semi-truck 805 is not running. In this way, the retractable bathroom 107 may receive power without requiring the user 105 to keep the engine in idle, which may allow the user 105 to save fuel. In some preferred embodiments, the auxiliary power unit may be a 12-volt DC having inverters for conversion to 110-volt AC, which may be a preferred embodiment for a retractable bathroom 107 attached to a barracks.

FIG. 9 provides a flow chart 900 illustrating certain, preferred method steps that may be used to carry out the method of using the retractable bathroom 107 to take a shower. Step 905 indicates the beginning of the method. During step 910 the user 105 may obtain a semi-truck 805 having a retractable bathroom 107 attached thereto. Once obtained, the user 105 may deploy the retractable bathroom 107 by changing its location during step 915. In a preferred embodiment, the user 105 may locate the retractable bathroom 107 using a deployment device. The user 105 may then place the retractable bathroom 107 in an open position during step 920, which may also be accomplished using the deployment device. Once deployed, the user 105 may access the interior of the retractable bathroom 107 during step 925 and subsequently place the shower curtain rod 3 in an extended position during step 930. In one preferred embodiment, the shower curtain rod 3 is automatically placed in an extended position when the retractable bathroom 107 is placed in an open position, obviating the necessity for a user 105 to perform step 930. Once the user 105 has placed the shower curtain rod 3 in an extended position, the user 105 may proceed to take a shower during step 935.

Once the user 105 has finished taking a shower within the retractable bathroom 107, the user 105 may place the shower curtain rod 3 in a folded position during step 940 and subsequently exit the retractable bathroom 107 during step 945. If the shower curtain rod 3 and retractable bathroom 107 are designed to automatically alter positions with respect to one another, then a user 105 may proceed to step 945 from step 935. Once the user 105 has exited the retractable bathroom 107, the user 105 may operate the deployment device to place the retractable bathroom 107 in a closed position and then alter the location of the retractable bathroom 107 to a location behind the cab of the semi-truck 805 during steps 950 and 955, respectively. The method may then proceed to the terminate method step 960. In some embodiments of the retractable bathroom 107, a user 105 may need to perform additional steps to place the sink 7 in an unfolded position and the toilet 13 in a rotated position prior to using the facilities of the retractable bathroom 107. For instance, a trucker may desire to use the toilet 13 without taking a shower. The user 105 in such a situation would not be required to place the shower curtain rod 3 in an extended position, but they may be required to place the toilet 13 in a rotated position.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter.

What is claimed is:

1) A system for a retractable bathroom comprising:
a folding frame having a front panel, top panel, floor panel, first side panel, second side panel, and back panel,
wherein said top panel further comprises a top folding panel,
wherein said floor panel is generally connected to said front panel perpendicularly,
wherein said floor panel further comprises a folding floor panel,
wherein said folding floor panel is generally in plane with said floor panel when placed in an open position,
wherein said first side panel is generally connected to said front panel perpendicularly,
wherein said second side panel is generally connected to said front panel perpendicularly,
wherein a folding wall is generally in plane with said second side panel when placed in said open position,
wherein an access panel is generally in plane with said first side panel when placed in said open position,
wherein said back panel generally connects to said a top folding panel, folding floor, access panel, and folding wall perpendicularly when placed in an open position,
a shower having a shower curtain rod, shower head, water pump, at least one water tank, and water supply lines,
wherein said shower curtain rod may be placed into a folded position or an extended position,
wherein said water supply lines connect said at least one water tank to said water pump,
wherein said water supply lines connect said at least one water tank to said shower head, and
a deployment device configured to move said folding frame from a first location to a second location,
wherein said first location has storage space to store said folding frame when said folding frame is in a closed position,
wherein said second location has expansion space to expand said folding frame when said folding frame is placed in an open position.

2) The system of claim 1, wherein said front panel and said top panel are fused to create a cab panel, wherein said cab panel defines dimensions of said folding frame when placed in said closed position.

3) The system of claim 1, further comprising a water heater,
wherein at least one of said shower head, water pump, and at least one water tank is connected to said water heater via said water supply lines.

4) The system of claim 1, further comprising a folding sink having a water basin and faucet,
wherein said faucet is connected to at least one of said at least one water tank and said water pump via said water supply lines.

5) The system of claim 4, further comprising a hinge of said folding sink,
wherein said water basin may be rotated about said hinge in a way such that folding sink may be placed in an up position and a down position,
wherein said folding sink cannot receive water within said water basic when said water basin is placed in said up position, and
wherein said folding sink cannot receive water within said water basic when said water basin is placed in said down position.

6) The system of claim 5, wherein said folding sink has a profile that is reduced in size when placed in said up position.

7) The system of claim 6, further comprising a toilet situated on said floor panel.

8) The system of claim 7, wherein said toilet comprises a toilet basin, flushing lever, water release valves, and black water pipe,
wherein said water release valves are connected to at least one of said at least one water tank and water pump via said water supply lines,
wherein manipulation of said flushing lever causes said water release valves and said water pump to transfer water to said toilet basin, and
wherein said black water pipe connects said toilet basin to said at least one water tank.

9) The system of claim 1, wherein said deployment device further comprises a pump, fluid, reservoir, control valves, user control, actuator connected to said pump via a plurality of tubes, and a plurality of seals,
wherein said user control is operably connected to said control valves,
wherein a user may input commands into said user control in way such that said user control causes said control valves to direct said fluid to said actuator, and
wherein manipulation of said actuator causes said folding frame to be placed in one of said first location and said second location.

10) The system of claim 9, wherein manipulation of said actuator causes said folding frame to be placed in one of said open position and said closed position.

11) A system for a retractable bathroom comprising:
a folding frame having a front panel, top panel, floor panel, first side panel, second side panel, and back panel,
wherein said top panel further comprises a top folding panel,
wherein said floor panel is generally connected to said front panel perpendicularly,
wherein said floor panel further comprises a folding floor panel,
wherein said folding floor panel is generally in plane with said floor panel when placed in an open position,
wherein said first side panel is generally connected to said front panel perpendicularly,
wherein said second side panel is generally connected to said front panel perpendicularly,
wherein a folding wall is generally in plane with said second side panel when placed in said open position,
wherein an access panel is generally in plane with said first side panel when placed in said open position,
wherein said back panel generally connects to said top folding panel, folding floor, access panel, and folding wall perpendicularly when placed in an open position,
a folding sink having a water basin, faucet, water pump, at least one water tank, and water supply lines,
wherein said water supply lines connect said at least one water tank to said water pump,
wherein said faucet is connected to at least one of said at least one water tank and said water pump via said water supply lines,
wherein said water basin is rotatable attached to a hinge in a way such that said water basin may be placed in one of an up position and a down position,
wherein said folding sink cannot receive water within said water basin when said water basin is placed in said up position,
wherein said folding sink can receive water within said water basin when said water basin is placed in said down position,
wherein said folding sink has a profile that is reduced in size when placed in said up position as opposed to said profile when placed in said down position, and
a deployment device configured to move said folding frame from a first location to a second location,
wherein said first location has storage space to store said folding frame when said folding frame is in a closed position,
wherein said second location has expansion space to expand said folding frame when said folding frame is placed in an open position.

12) The system of claim 11, further comprising a water heater,
wherein at least one of said faucet, water pump, and at least one water tank are connected to said water heater via said water supply lines.

13) The system of claim 11, further comprising a toilet situated on said floor panel.

14) The system of claim 13, wherein said toilet comprises a toilet basin, flushing lever, water release valves, and black water pipe,
wherein said water release valves are connected to at least one of said at least one water tank and water pump via said water supply lines,
wherein manipulation of said flushing lever causes said water release valves and said water pump to transfer water to said toilet basin, and
wherein said black water pipe connects said toilet basin to said at least one water tank.

15) The system of claim 11, wherein said deployment device further comprises a pump, fluid, reservoir, control valves, user control, actuator connected to said pump via a plurality of tubes, and a plurality of seals,
wherein said user control is operably connected to said control valves,
wherein a user may input commands into said user control in way such that said user control causes said control valves to direct said fluid to said actuator, and
wherein manipulation of said actuator causes said folding frame to be placed in one of said first location and said second location.

16) The system of claim 15, wherein manipulation of said actuator causes said folding frame to be placed in one of said open position and said closed position.

17) A system for a retractable bathroom comprising:
a folding frame having a front panel, top panel, floor panel, first side panel, second side panel, and back panel,
wherein said top panel further comprises a top folding panel,
wherein said floor panel is generally connected to said front panel perpendicularly,
wherein said floor panel further comprises a folding floor panel,
wherein said folding floor panel is generally in plane with said floor panel when placed in an open position,
wherein said first side panel is generally connected to said front panel perpendicularly,
wherein said second side panel is generally connected to said front panel perpendicularly,
wherein a folding wall is generally in plane with said second side panel when placed in said open position,
wherein an access panel is generally in plane with said first side panel when placed in said open position,
wherein said back panel generally connects to said top folding panel, folding floor, access panel, and folding wall perpendicularly when placed in an open position,
a toilet having a toilet basin and situated on said floor panel, and
a deployment device configured to move said folding frame from a first location to a second location,
wherein said first location has storage space to store said folding frame when said folding frame is in a closed position,
wherein said second location has expansion space to expand said folding frame when said folding frame is placed in an open position.

18) The system of claim 17, wherein said toilet comprises a toilet basin, flushing lever, water release valves, water supply lines, at least one water tank, water pump, and black water pipe,
wherein said water release valves are connected to at least one of said at least one water tank and water pump via said water supply lines,
wherein manipulation of said flushing lever causes said water release valves and said water pump to transfer water to said toilet basin from said at least one water tank, and
wherein said black water pipe connects said toilet basin to said at least one water tank.

19) The system of claim 17, wherein said deployment device further comprises a pump, fluid, reservoir, control valves, user control, actuator connected to said pump via a plurality of tubes, and a plurality of seals,
wherein said user control is operably connected to said control valves,
wherein a user may input commands into said user control in way such that said user control causes said control valves to direct said fluid to said actuator, and
wherein manipulation of said actuator causes said folding frame to be placed in one of said first location and said second location.

20) The system of claim 19, wherein manipulation of said actuator causes said folding frame to be placed in one of said open position and said closed position.
